(19) United States
(12) Patent Application Publication
(10) Pub. No.: US 2016/0143494 A1
(43) Pub. Date: May 26, 2016

(54) Bathroom Weight Support

(71) Applicant: Robert Thomas, Waldorf, MD (US)

(72) Inventor: Robert Thomas, Waldorf, MD (US)

(21) Appl. No.: 14/943,200

(22) Filed: Nov. 17, 2015

Related U.S. Application Data
(60) Provisional application No. 62/084,249, filed on Nov. 25, 2014.

(51) Int. Cl. A47K 17/02; G08B 25/01; G08B 3/10

(52) U.S. Cl. CPC A47K 17/024; G08B 3/1008; G08B 25/016

(57) ABSTRACT

A bathroom weight support that is configured to prevent a user from falling from a seated position. The bathroom weight support includes a first member that is pivotally attached to a second member at one end. The first member is configured to be attached to a bathroom wall or similar support structure. The second member is substantially in an L-shape, which encloses a user along his or her side and torso while in a seated position and prevents falling and the possibility of an injury. The first member further includes a support rod that helps the second member to move from a retracted position to an extended position. The support rod is controlled by a depressible button, which the user can use to deploy the support rod and second member.

### CROSS REFERENCE TO RELATED APPLICATION

This application claims the benefit of U.S. Provisional Application No. 62/084,249 filed on Nov. 25, 2014. The above identified patent application is herein incorporated by reference in its entirety to provide continuity of disclosure.

### BACKGROUND OF THE INVENTION

### Field of the Invention

The present invention relates to bathroom accessories. More specifically, the present invention pertains to an improved bathroom weight support that is configured to allow a user to brace his weight thereon while using a toilet, taking a bath, or taking a shower, in order to prevent the user from falling.

Activities that take place in the bathroom, such as showering, bathing, or using the toilet are an important part of a person's daily routine. However, incidents, such as falls or seizures, while using the bathroom may cause serious injuries. Certain home safety measures can be taken to reduce the risk for all household members of being injured in the bathroom, such as adding grab bars inside and outside of the tub, shower, and near the toilet for added support. However, these safety measures are related to preventative strategies for slips and falls.

In other situations, a person having an epileptic seizure or a heart condition can lose consciousness while taking a shower or bath in a seated position, or using the toilet. Falls in these types of situations are particularly dangerous and cannot be cured by the use of grab bars. Therefore, there exists a need for a preventive measure that supports a user's weight in the case of an emergency in the bathroom so as to prevent the user from falling and injuring himself or herself.

The present invention provides a bathroom weight support that is configured to aid a user in standing up from a seated position, and that further helps to prevent the user from falling. The bathroom weight support comprises a first member having a first end and a second end configured to be secured to a support surface such as a bathroom wall or a bathroom showier wall. The second end is pivotally attached to a second member that is substantially L-shaped. The second member is placed adjacent and substantially coplanar to the first member in a retracted position, however, it is configured to extend outwardly in a singular plane and into a perpendicular position in relation to the first member. The perpendicular position is particularly advantageous as it encloses a user along his side and torso to support the weight of the user that is falling and possibly mitigating injuries due to falling.

### SUMMARY OF THE INVENTION

In view of the foregoing disadvantages inherent in the known types of bathroom weight supports now present in the prior art, the present invention provides a new and improved bathroom weight support wherein the same can be utilized to aid a user in standing back up when using a toilet or simply stopping the person from falling while using the same.

It is therefore an object of the invention to provide a new and improved bathroom weight support that has all of the advantages of the prior art and none of the disadvantages.

Another object of the present invention is to provide a new and improved bathroom weight support that comprises a first member configured to be secured to a bathroom wall and a second member pivotally attached to the first member that extends outward therefrom.

Yet another object of the present invention is to provide a new and improved bathroom weight support, wherein the second member is configured to extend outwardly in a singular plane into a perpendicular position in relation to the first member.

Still yet another object of the present invention is to provide a new and improved bathroom weight support, further comprising a support rod that is configured to extend and retract the second member from the retracted position to the perpendicular position.

Another object of the present invention is to provide a new and improved bathroom weight support, further comprising a depressible button that is in communication with the support rod allowing the depressible button to control the deployment of the bathroom weight support into the perpendicular position.

Still yet another object of the present invention is to provide a new and improved bathroom weight support wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a side perspective of the present invention in a retracted position.

FIG. 2 shows a side perspective of the present invention in an extended position.

FIG. 3 shows a schematic diagram of the bathroom weight support.

### DETAILED DESCRIPTION OF THE INVENTION

References are made herein to the attached drawings. Like reference numerals are used throughout the drawings to depict like or similar elements of the bathroom weight support. For the purposes of presenting a brief and clear description of the present invention, the preferred embodiment will be discussed as used to help a user stand from a seated position or to prevent a user from falling while using a toilet, taking a bath, or taking a shower in the case of an emergency. The figures are intended for representative purposes only and should not be considered to be limiting in any respect.

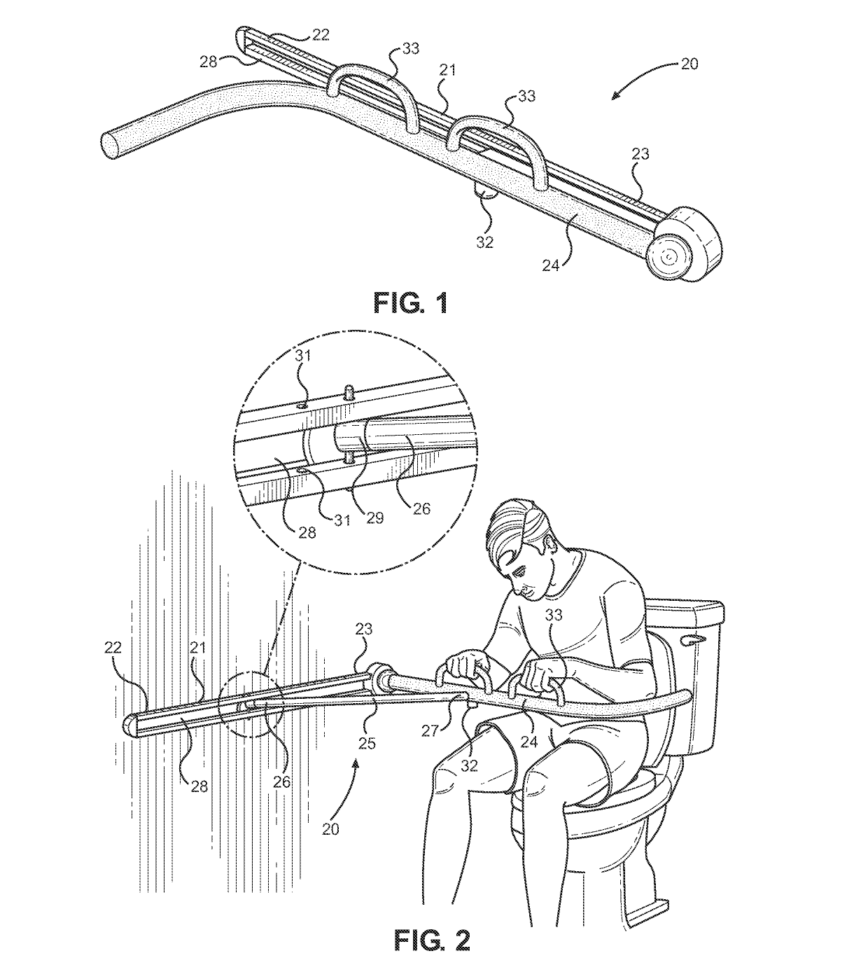

Referring now to FIGS. 1 and 2, there is shown a side perspective view and an overhead perspective of the bathroom weight support. The bathroom weight support 20 comprises a first member 21 having a first end 22 and a second end 23 configured to be secured to a support surface, preferably a bathroom wall or a bathroom shower wall. The first member 21 is an elongated rod that is preferably substantially linear.

A second member 24 is pivotally affixed to the second end 23 of the first member 21. The second member 24 preferably comprises an L-shaped configuration and can be used as a support for a user to hold onto in order to prevent the user from falling or to help the user to move to a standing position. The second member 24 preferably comprises one or more handles 33 thereon, wherein the handles are shown as having a U-shaped configuration. The second member 24 is movable between a retracted configuration and an extended configuration. In the retracted configuration, the second member 24 is placed adjacent to and substantially parallel to the first member 21. In the extended configuration, the second member 24 can be pivoted away from the first member 21 in a horizontal plane such that the second member 24 is substantially perpendicular to the first member 21. The L-shaped configuration of the second member 24 is adapted to extend across the user's body and around the side thereof so as to partially surround or enclose the user, helping to prevent the user from falling.

A support rod 25 is movably affixed to the first member 21 and to the second member 24. The support rod 25 includes a proximal end 26 and a distal end 27, wherein said proximal end 26 is configured to slide along a track 28 disposed on the first member 21 and the distal end 27 is pivotally attached on the second member 24. The track 28 extends from the first end 22 of the first member 21 to the second end 23 thereof.

The proximal end 26 comprises a fastener 29 thereon that is adapted to lock the support rod 25 in a fixed position, thus locking the second member 24 in a fixed position. The fastener 29 is preferably a self-locking fastener, such as a pair of spring-biased locking pins adapted to extend through one or more apertures 30 disposed on the track 28. However, other fasteners may be used in alternate embodiments so as to lock the second member 24 in the extended configuration.

The distal end 27 of the support rod 25 is pivotally affixed to the second member 24. Preferably, the distal end 27 is affixed in a substantially central location thereon. When the bathroom support weight 20 is in the retracted position, the support rod 25, first member 21, and second member 24 are all positioned substantially in an adjacent and coplanar manner. However, as the second member 24 is deployed and disposed in the perpendicular position, the support rod 25 is placed at an angle to prevent the second member 24 from being pushed back towards the retracted position as a user applies force thereto. In this way, the support rod 25 provides a sturdy construction for the bathroom weight support that allows the user to brace himself thereon, which can aid in standing up or prevent the user from falling to the ground in the case of an emergency.

The second member 24 further comprises a depressible button 32 having a means for releasing said fastener 29, wherein a user can first apply pressure to the depressible button 32 to deploy the support rod 25 and the second member 24 from the retracted configuration to the extended configuration. A second application of pressure to the depressible button 32 unlocks the bathroom weight support 20 from the perpendicular position and allows the user to return the second member 24 back to the retracted position.

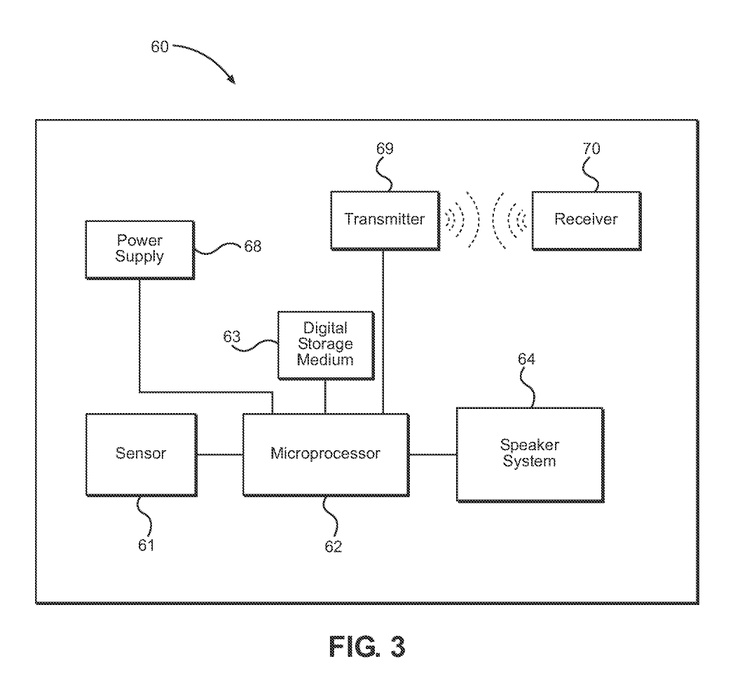

Referring now to FIG. 3, there is shown a schematic diagram of an alternative embodiment of the bathroom weight support. In an alternative embodiment, the deployment of the support rod and the second member triggers an alert assembly 60. The alert assembly 60 includes a sensor 61, a microprocessor 62, a digital storage medium 63, and a speaker system 64.

The sensor 61 is configured to detect the deployment of the bathroom weight support. The sensor may comprise a reed switch or other similar sensor for detecting the movement of the support rod and second member from the retracted configuration to the extended configuration. The deployment of the second member triggers the sensors 61 to transmit a digital signal to the microprocessor 62. The microprocessor 62 is coupled with a digital storage medium 63, wherein the microprocessor 62 is configured to retrieve a digital alert file and transmit the digital alert file to the speaker system 64. The digital alert file is then played via the speaker system 64 so as to provide an audible alert to notify a nearby caretaker that the user may require assistance.

In another alternative embodiment, the alert assembly 60 also includes a transmitter 69, which sends a wireless alert signal to an appropriate receiver 70 that can be held by a caretaker or a guardian. In some embodiments, the receiver may comprise a cell phone or other mobile electronic device. The transmitter 69 is electrically coupled to the microprocessor 62 and the power source 68, wherein the transmitter 69 is prompted to send the wireless alert signal upon receipt of a digital signal from the microprocessor 62. The transmitter 69 may use wireless technology known in the art to connect to a router, modem, or other device to obtain telephonic, internet or other data transmission access.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A bathroom weight support, comprising:
a first member having a first end and a second end, wherein the first member is adapted to be affixed to a support surface;
a second member pivotally attached to the second end of the first member such that the second member is movable between a retracted configuration and an extended configuration wherein the second member is substantially perpendicular to the first member so as to provide support for a user;
a support rod connecting the first member and the second member that facilitates movement between the retracted configuration and the extended configuration.

2. The bathroom weight support of claim 1, wherein the second member comprises an L-shaped configuration.

3. The bathroom weight support of claim 1, wherein a proximal end of the support rod is movably positioned within a track disposed on the first member, such that the proximal end of the support rod can move therein.

4. The bathroom weight support of claim 4, wherein the first end of the support rod comprises a fastener thereon adapted to lock the support rod in a fixed position.

5. The bathroom weight support of claim 1, further comprising an alert system adapted to produce an audible alert when the second member is moved to the extended configuration.

6. The bathroom weight support of claim 1, further comprising an alert system having a microprocessor, a speaker system, a power source, and a storage medium.

7. The bathroom weight support of claim 6, further comprising a transmitted adapted to send a signal to a receiver so as to allow a user to obtain assistance from a third party.
